(19) United States
(12) Patent Application Publication
(10) Pub. No.: US 2014/0244040 A1
(43) Pub. Date: Aug. 28, 2014

(54) SYSTEMS, DEVICES, AND METHODS FOR ASSOCIATING DEVICES FOR BUILDING AUTOMATION AND ENERGY MANAGEMENT

(71) Applicant: Green Edge Technologies, Inc., Poway, CA (US)

(72) Inventors: William P. Alberth, JR., Prairie Grove, IL (US); Seang Yong Chau, San Jose, CA (US); David K. Hartsfield, Poway, CA (US); William Rice, San Diego, CA (US); Scott A. Steele, Poway, CA (US)

(21) Appl. No.: 13/777,885

(22) Filed: Feb. 26, 2013

(51) Int. Cl. H04L 12/28; H02J 4/00; G05B 15/02

(52) U.S. Cl. CPC H04L 12/2803; G05B 15/02; H02J 4/00
USPC 700/275; 700/295

(57) ABSTRACT

Embodiments of the present disclosure include a method for associating at least two components of a plurality of components of a building automation system. In one embodiment, the method may include operating a first component of the at least two components in a first mode to issue commands to one of the other components of the automation system and a second component of the at least two components, wherein the first component is a control device and the second component is controlled by the first component. The method may further include operating the first component in a second mode, wherein the second mode facilitates altering a relationship between the first and second components.

### FIELD OF THE INVENTION

Embodiments of the present disclosure relate to systems, devices, and methods for automation and energy management. More particularly, the present disclosure is directed to initializing and associating (e.g., by pairing, coupling, or linking) one or more energy consumption devices with appropriate control devices.

### BACKGROUND OF THE INVENTION

Conventional home automation systems have been available in the marketplace for many years. For example, the internationally-known X10 standard was one of the first standards commercialized for automating systems within a home, office, school, or other structure or dwelling. The X10 standard enables commands to be sent over the existing wiring in a structure, so that a controller can send messages to a controlled device. That is, one or more devices may communicate with one another over existing electrical wiring using the X10 standard. Controllers and controlled devices can be paired by manually setting the address or identifying information on the respective devices. Recent efforts to conserve energy have sparked additional interest in home automation. The existing and available solutions in the prior art, however, require large expenditures of capital and/or expert domain knowledge to facilitate installation. The current known prior art solutions are further limited by the fact that conventional outlets function in the same way regardless of the load (e.g., the particular electronic device) operably coupled to the outlet. In other words, a conventional outlet functions exactly the same regardless of whether a refrigerator, a clock radio, an incandescent, LED, or fluorescent light, a vacuum cleaner, a life support device, or another electronic device is plugged into the outlet. Such inflexible and non-discriminatory outlet set-up is not cost efficient, and does not optimize energy conservation.

There are solutions to differentiate the type of loads connected to an electrical network. For example, U.S. Pat. No. 8,094,034, entitled “Detecting Actuation of Electrical Devices Using Electrical Noise Over a Power Line,” discloses apparatus and methods for detecting electrical device actuation using electrical noise over a power line.

In addition, conventional power outlets do not readily allow differing controllers to regulate power delivery from the outlet. That is, conventional outlets are typically controlled by a single controller, such as, e.g., a switch, which may be disposed remotely of the outlet. Therefore, among other things, a more convenient method is needed to map or remap remote switches to remote outlets. In addition, an improved method and solution are needed to facilitate easy association of devices and their controllers that are part of a home automation system.

### SUMMARY OF THE INVENTION

The previously mentioned disadvantages and limitations are overcome and other advantages are achieved with the embodiments described below.

In one embodiment, the present disclosure describes an automation system, including, but not limited to, a controller, remote switches, and remote outlets. The remote outlets may be configured to monitor power consumed by appliances plugged into the outlets, and the system may be configured to make a determination about the appliance. The determination may include identifying one or more characteristics of the appliance. In addition, the present disclosure describes, among other things, a method for selectively controlling an outlet or an appliance electrically coupled to the outlet by way of a pairing procedure. In one embodiment, when a pairing is performed, an appliance may be powered on or off to facilitate identifying control by a user interface, and allowing the user to select whether the subject appliance or another appliance is desired to be controlled by, e.g., a remote switch.

In another embodiment, a web application or an application on a mobile device may be capable of identifying candidate or otherwise controllable devices and remote switches, while enabling the user to select which devices should be paired with which remote switches. Embodiments of the disclosed method may also enable a remote switch to be paired with multiple outlets or candidate devices, so that a single switch can be easily paired to and control multiple devices.

Embodiments of the present disclosure are directed to systems, devices, and methods for intelligently controlling one or more energy consuming devices in a structure, including, but not limited to, a home, office, hospital, sporting complex, or school.

In one embodiment, a building automation system may include a controller and at least one outlet for providing electrical energy to one or more electrical devices, wherein the at least one outlet may include a power monitor, at least one sensor, and a communication link configured to allow communication between the outlet and the controller. The building automation system may include one or more features of the building automation system disclosed in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference.

Various embodiments of the building automation system may include an outlet, at least one sensor, a controller, and/or a switch, and may include one or more of the following features: the outlet may include an adaptor configured to be operably coupled with a preexisting electrical outlet; the at least one sensor may include a plurality of sensors; the at least one sensor may include one of a motion sensor, light sensor, and a temperature sensor; the outlet may include a microprocessor; one of the controller and microprocessor may be configured to receive power consumption data for the one or more electrical devices from the power monitor; one of the controller and microprocessor may be configured to compare the received power consumption data to power consumption data of known electrical devices; one of the controller and microprocessor may be configured to identify the one or more electrical devices based on the comparison of the received power consumption data to power consumption data of known electrical devices; the at least one outlet may be configured to detect an electrical noise in a power line generated by the one or more electrical devices; the at least one outlet may be configured to communicate the detected electrical noise to the controller; the controller may be configured to compare the detected electrical noise to electrical noise data of known electrical devices; the controller may be configured to identify the one or more electrical devices based on the comparison of the detected electrical noise to electrical noise data of known electrical devices; the sensor may be configured to detect a radiofrequency signal; a switch operably coupled to the controller and the outlet; the controller may be configured to communicate with the Internet; the communication link may be configured to allow wireless communication between the outlet and the controller; and the controller may be configured to terminate delivery of electrical energy to the at least one outlet based on an input from the at least one sensor.

In another embodiment, a building automation system may include a controller, and an outlet for providing electrical energy to an electrical device, wherein the outlet may be an adaptor configured to be connected to an existing electrical outlet in the building. The outlet may include a power monitor configured to monitor a power consumption of the electrical device. The outlet may also include any suitable sensor including, e.g., a motion sensor, light sensor, and/or temperature sensor. Further, the outlet may include an antenna or other appropriate hardware configured to allow wireless communication between the controller and the outlet.

Various embodiments of the building automation system may include one or more of the following features: the outlet may be configured to detect an electrical noise in a power line generated by the electrical device; the building automation system may be configured to identify the electrical device based on a comparison of the monitored power consumption of the electrical device to power consumption of known devices; the building automation system may be configured to identify the electrical device based on a comparison of the detected electrical noise to electrical noise of known devices; the outlet may be further configured to detect radiofrequencies; a switch, e.g., a remote switch, operably coupled to the controller and the outlet; and the switch may be configured to interrupt a supply of electrical energy to the outlet.

In another embodiment, a building automation system may include a controller and an outlet for providing electrical energy to an electrical device. The outlet may include a power monitor configured to monitor a power consumption of the electrical device and at least one sensor. The building automation system may be configured to identify the electrical device based on a comparison of the monitored power consumption of the electrical device to power consumption of known devices.

Various embodiments of the building automation system may include one or more of the following features: the outlet may be an adaptor configured to be electrically coupled to an existing electrical outlet in the building; and the at least one sensor may be configured to sense one or more of motion, light, temperature, and/or any desired parameter of the surroundings of the outlet.

In a further embodiment, a building automation system may include a controller and an outlet for providing electrical energy to an electrical device, wherein the outlet is configured to detect an electrical noise in a power line generated by the electrical device. Furthermore, the building automation system may be configured to identify the electrical device based on a comparison of the detected electrical noise to electrical noise of known devices.

Various embodiments of the building automation system may include one or more of the following features: a sensor configured to sense at least one of motion, light, temperature, and sound; and the outlet may be an adaptor configured to be electrically coupled to an existing electrical outlet in the building.

In a further embodiment, a method may include operating a first component of the at least two components in a first mode to issue commands to one of the other components of the automation system and a second component of the at least two components, wherein the first component is a control device and the second component is controlled by the first component. The method may further include operating the first component in a second mode, wherein the second mode facilitates altering a relationship between the first and second components.

In a further embodiment, a system for remotely controlling a delivery of electrical energy may include a switch having a user interface, a plurality of components configured to delivery electrical energy, and a mobile device, wherein manipulating the user interface of the switch controls delivery of electrical energy from one or more of the plurality of components, wherein the mobile device is wirelessly coupled with the switch, and wherein the mobile device may be used to designate which of the plurality of components is to be controlled by the switch.

Various embodiments of the system may include one or more of the following features: the first component may be configured to control a flow of electrical energy at the second component; the first component may be configured to receive a user input; providing multiple user inputs within a predetermined period of time places the first component in the second mode; the at least two components include at least a third component, wherein the second and third of the at least three components define a first set of components, wherein the first component is configured to individually or collectively control each of the components of the first set of components; at least one of the components in the first set of components is coupled to an electrical device; at least one of the components in the first set of components is coupled to an electrical device drawing electrical energy from the at least one of the components; at least one of the components in the first set of components is connected to an electrical device determined to be essential and should not experience an interruption in power delivery; the components of the first set of components are ordered by proximity to the first component; the first component is configured to measure a signal emitted by the second and third components; proximity to the first component is determined by measuring a magnitude of the signals emitted by the second and third components; when in the first mode, the first component emits a signal to interrupt delivery of electrical energy from at least one of the components in the first set of components; wherein, when in the second mode, activating the first component a first time causes the first component to emit a signal configured to be received by the first member of the first set of components that is closest to the first component, wherein the signal includes instructions to interrupt delivery of electrical energy from the first member of the first set of components; wherein, when in the second mode, activating the first component a second time causes the first component to emit a signal configured to be received by another component of the first set of components, wherein the signal includes instructions to interrupt delivery of electrical energy; wherein no further activations of the first component in the second mode causes the first component to exclusively control the another component of the first set of components.

In another embodiment, a system for remotely controlling a delivery of electrical energy may include a switch including a user interface, a plurality of components configured to delivery electrical energy; and a mobile device; wherein manipulating the user interface of the switch controls delivery of electrical energy from one or more of the plurality of components, wherein the mobile device is wirelessly coupled with the switch, and wherein the mobile device may be used to designate which of the plurality of components is to be controlled by the switch.

Various embodiments of the system may include one or more of the following: the switch includes a plurality of switches; the mobile device includes a display configured to graphically represent each of the plurality of switches and each of the plurality of components; the mobile device is wirelessly coupled to each of the plurality of components; the display is configured to graphically represent one or more characteristics of each of the plurality of switches and each of the plurality of components; the one or more characteristics includes a mode of operation; the mobile device may be used to selectively control the delivery of power from at least one of the plurality of components; controlling the delivery of power includes first selecting the at least one of the plurality of components; selecting the at least one of the plurality of components temporarily interrupts the delivery of electrical energy to the at least one of the plurality of components; wherein the mobile device may be used to associate one switch of the plurality of switches with at least one of the plurality of components, wherein, after successful association, the switch controls delivery of electrical energy from the at least one of the plurality of components; the at least one of the plurality of components is electrically coupled to an electrical device, wherein the at least one of the plurality of components is configured to monitor a quantity of electrical energy delivered to the electrical device; the quantity of electrical energy is displayed on the mobile device.

In another embodiment, a wireless electrical energy control device may include an actuator for controlling a flow of electrical energy, wherein, in a first position, the actuator allows electrical energy to flow, and, in a second position, the actuator selectively prevents energy from flowing; an electrical coupling for operably connecting the control device to an electrical outlet, wherein the electrical coupling is configured to transition between a first stored configuration and a second extended configuration; and a power source, wherein physically connecting the control device to the electrical outlet configures the control device in such a manner that the actuator is capable of controlling a flow of electrical energy from the electrical outlet when the control device and electrical outlet are not connected. Further, the power source may include a rechargeable battery, and wherein the rechargeable batter is configured to recharge when the control device is physically connected to the electrical outlet.

It may be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 schematically illustrates components of an exemplary automation system, in accordance with an embodiment of the present disclosure;

FIG. 2 illustrates a block diagram of an exemplary switch that can provide control signals within the automation system of FIG. 1;

FIG. 3 illustrates a block diagram of an exemplary outlet for use with the automation system of FIG. 1;

FIG. 4 depicts a flowchart of an exemplary method for operating an enhanced automation system, in accordance with an embodiment of the present disclosure;

FIG. 5 depicts a flowchart of an exemplary method for controlling an embodiment of an automation system disclosed herein, in accordance with the present disclosure;

FIGS. 6 through 12 depict an exemplary user interface used to control aspects of an automation system disclosed herein, in accordance with the present disclosure.

### DETAILED DESCRIPTION OF THE EMBODIMENTS

Reference now will be made in detail to embodiments of the present disclosure, examples of which are illustrated in the accompanying drawings. Wherever possible, the same reference numbers will be used throughout the drawings to refer to the same or like parts and/or components.

In one embodiment, a home automation system may include one or more switches and one or more outlets, with the user desiring which outlet or outlets are controlled by a particular switch or switches. Existing X10 devices require the user to manually set an address on the switch and the outlet, thereby encoding the outlet and switch so that they may communicate with one another. That is, an outlet would respond to a switch with an identical address, which would allow the switch to enable or disable power to the outlet on command of the identically addressed switch. This existing method may be limited to the available addresses which can be mechanically selected, and also requires physical access to the switch and the device (e.g., an outlet) being controlled. In addition, this existing method may create conflicts in situations in which one or more outlets and one or more switches share a particular encoding. Furthermore, some newly constructed buildings have the outlets in the ceiling to facility low cost remodeling and to enable the building to accommodate future equipment, such as, e.g., a projector. In such situations, it would be inconvenient to require a person to climb a ladder any time a ceiling mounted outlet or ceiling fixture was to be controlled by a remote switch.

Normal operation for a switch is for the user to turn the switch to an “ON” position to enable electrical energy to flow to the correspondingly controlled outlet (or device coupled to the outlet), and turn the switch to an “OFF” position to terminate the flow of electrical energy to the outlet (or device coupled to the outlet). In some cases, the switch may include an intermediate position, which meters an amount of voltage or current delivered to the outlet. In one embodiment of the present disclosure, turning the switch on and off several times in a short time, or executing some other user input pattern, may signal a desire to pair the switch with an outlet or device, which may be remote to the switch.

In accordance with one embodiment, a switch of the present disclosure may be in communication with all possible outlets that can be controlled. The outlets include a power monitor configured to determine if an appliance is connected to the outlet and if the appliance is drawing power from the outlet. The home automation system may be configured to create a list of outlets that are in communication with the switch and, e.g., have a device electrically coupled to the outlet. The list may include information relating to an identifying characteristic of the device(s) coupled to the outlet.

In one embodiment, when the user causes a switch to enter a pairing mode, as described in greater detail below, the automation system would create (or populate) a list of outlets that can be controlled by the switch and terminate delivery of electrical energy (i.e., power) to those outlets, pause power delivery for a predetermined time period such as, e.g., 2 seconds, and then re-enable power delivery to the outlets. In this manner, the user would see the controllable appliances that can be controlled turn off and then on, informing the user which devices are capable of being paired with the switch.

Further operations of the switch, e.g., would momentarily terminate power delivery to successive outlets in the previously compiled list. After the last device is selected by flipping the switch between the “ON” and “OFF” positions, the selection would proceed back to the beginning of the list. Thus, the user could, by means of flipping the switch between the “OFF” and “ON” positions, cycle through outlets (and devices coupled thereto) capable of being controlled by the switch.

Once the user has identified an outlet/device to be paired with the switch, the user may leave the switch in position for a pre-determined time period, such as, e.g., 5 seconds. The selected device would be powered off and then on to indicate it has been selected and the switch would exit pairing mode.

In some embodiments, however, it may be detrimental to interrupt power delivery to certain devices/outlets solely for the sake of pairing a control switch. In such embodiments, the switches and/or outlets may include indication means, capable of communicating information to a user. For example, rather than interrupting power as described above, a light source or speaker on an outlet/switch may be activated to indicate to a user whether a particular switch is in pairing mode, whether a particular outlet may be paired with a switch, and when a particular outlet is indeed paired with a switch.

This method enables the user to easily change which switch controls which outlet without adding extra switches or user interface components. In addition. the appliances themselves become part of the user interface in an intuitive user-friendly method.

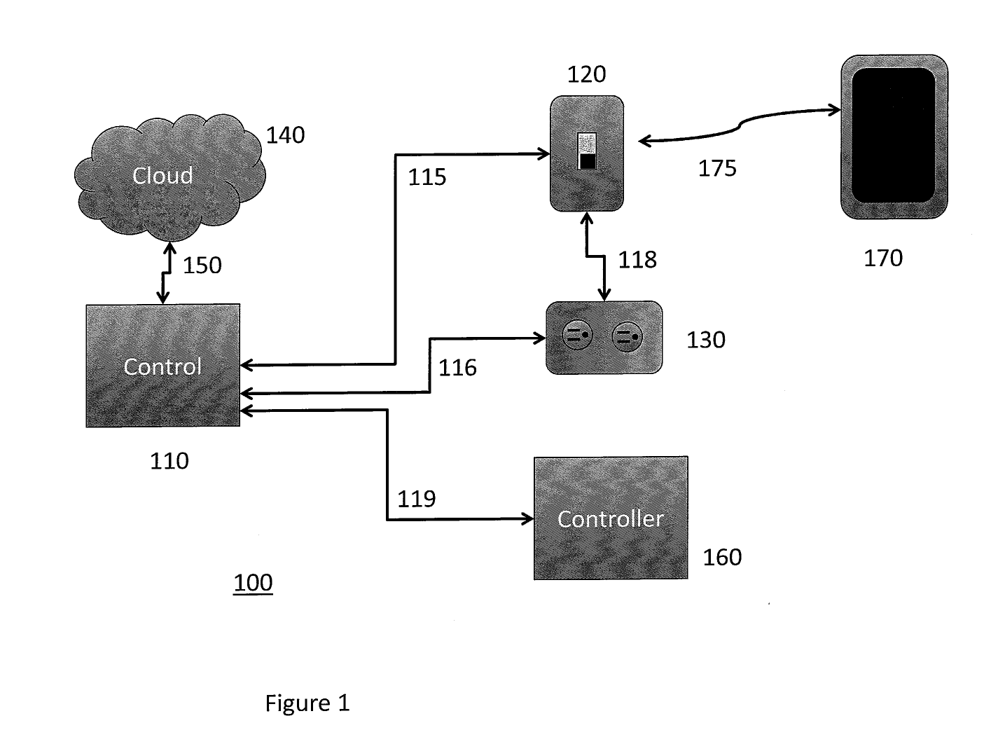

Embodiments of the present disclosure can be further understood with references to FIGS. 1 through 5. FIG. 1 depicts an automation system 100. System 100 may include any of the features of the automation system disclosed in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. For example, the system 100 may include an outlet 130, which can be remotely controlled, can monitor the power consumed by attached appliances, and can control the power delivered by the outlet. The system 100 may also include a remote switch 120, which can provide a control signal to the automation system. The switch 120 may be configured to control the delivery of electrical energy to outlet 130. Control 110 may be a computer containing a microprocessor, memory, and/or a user interface. Control 110 maybe a discrete control unit for the automation system 100, a laptop, desktop, tablet, or any other suitable device, which may be portable and/or fixedly secured to a structure within which automation system 100 may be employed. Control 110 may have any of the features of the control described in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. The control 110 is connected via wired or wireless network connection 150 to the cloud 140, which may be a network, such as the Internet. The control 110 may be also connected to the switch 120 via wired or wireless connection 115. The control 110 may be connected to the outlet 130 via wired or wireless connection 116. The remote switch 120 may be connected to the outlet 130 via wired or wireless connection 118.

System 100 also includes other automation enhancements such as, e.g., a controller 160 (e.g., a mechanical controller) for, among other things, controlling the operation of, e.g., remote window coverings, doors, window panes, skylights, vent covers, fans, ducts, etc. Controller 160 may have any of the features of the controller described in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. Controller 160 may be configured to receive instructions from the control 110 via wired or wireless connection 119. The remote switch 120 may also communicate with controller 160 using wired or wireless means, although this connection is not shown in FIG. 1. The connections 115, 116, and 118, and 119 may be the same or different protocols or standards. It is expected that some or all of the processing could be performed by a microprocessor in the remote switch 120 or remote outlet 130. The automation system 100 may be built in a single or multi-family dwelling, condo unit, apartment, office, or office building. It is also expected that a system 100 may include multiple switches 120, outlets 130, and controllers 160 controlling any number of enhancements, as described in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. For example, other devices such as moisture sensors may be attached to the system 100 via, e.g., controller 160, to provide information on the presence of water or rain.

A mobile device 170 may be wirelessly connected to the automation system 100 via wireless connection 175. The wireless connection 175 may be to the remote switch 120 as shown, it may also be to the remote outlet 130, controller 160, control 110, or any combination of these devices. The wireless transceiver in the mobile device 170 may include a method to measure received signal strength. The mobile device 170 may be connected through a Wi-Fi network and/or a cellular network (e.g., GSM or LTE).

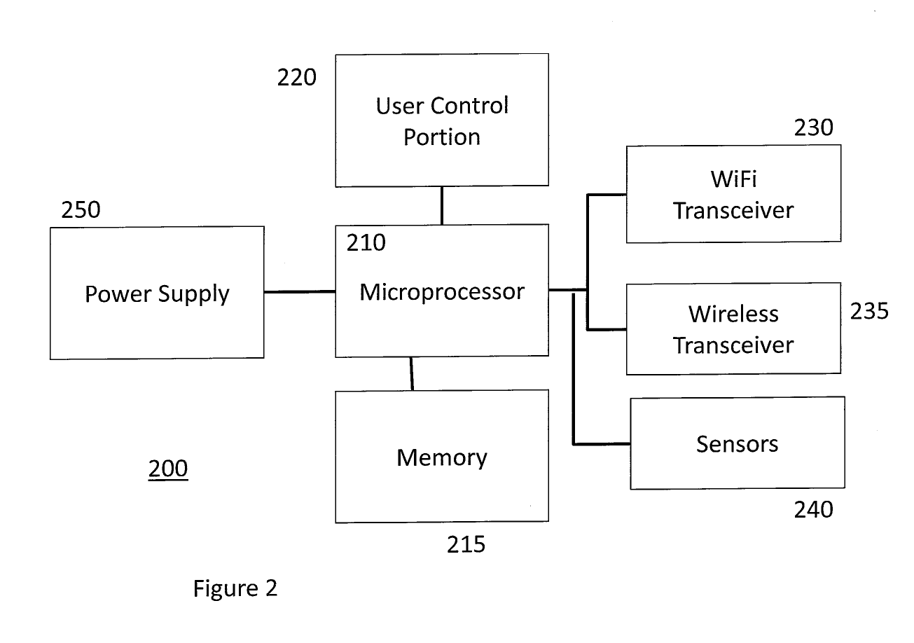

FIG. 2 is a block diagram for a remote switch 200 that can be incorporated as part of an automation system 100 and may operate as switch 120. Switch 200 may include one or more of the features of the switch disclosed in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. The switch 120 may include a microprocessor 210 capable of running software stored in a memory 215. The switch 120 includes a user operated control portion 220, which may be a mechanical switch configured to move between “ON” and “OFF” positions, or any of various user input devices known in the art, including, but not limited to, e.g., a touch sensor, push buttons, voice/sound activated interfaces, and/or remotely activated interfaces. As alluded to above, the user operated portion 220 may have two positions (on/off), or may allow various levels (e.g., current or voltage) to be indicated by the user discretely or continuously. That is, in one embodiment, the switch may include a dimming function, wherein a limited amount of voltage and/or current is delivered to, e.g., outlet 130. The switch includes a transceiver 230, which may include an 802.11 WiFi transceiver in the block diagram. The transceiver could be any wireless or wired standard, including but not limited to X10, zigbee, Bluetooth, or others.

With the transceiver 230, the switch 200 is able to send commands to a control device 110, such as the one described in FIG. 1. The switch 200 also may be capable of wirelessly communicating with any component of automation system 100. The transceiver 230 may exchange commands with a central control device 110 of the automation system 100. An optional wireless transceiver 235 may be included to allow the switch to communicate with controlled devices via multiple standards. Both transceivers 230 and 235 may include received signal strength indicator means to identify the strength of a signal received by the respective transceivers. The switch also may include sensors 240, such as motion sensors, ambient light sensors, camera, microphone, moisture sensors, etc. Sensors 240 may include any suitable sensors known in the art, including those described in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. The switch may also include a power supply 250, which could be a power supply hooked to the power grid or a standalone battery or both a connection to the grid and a battery. The power supply 250 may include any of the features of the power supply disclosed in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference.

With continued reference to FIG. 2, the microprocessor 210 is operable to receive inputs from any component of automation system 100, including, e.g., the sensors, switches 120, outlets 130, WiFi transceiver 230, Wireless Transceiver 235, and user control portion 220, and send out commands using the WiFi transceiver 230 or Wireless Transceiver 235, as will be explained in the following descriptions and corresponding flowcharts.

In addition, switch 200 may include a mechanism for monitoring a state of switch 200. That is, the mechanism may be capable of determining whether the switch 200 is in a first (which may be an “ON”) position, a second (which may be an “OFF”) position, or an intermediate position. Further, switch 120 may be capable of monitoring the time between a transition from the “ON” position to the “OFF” position.

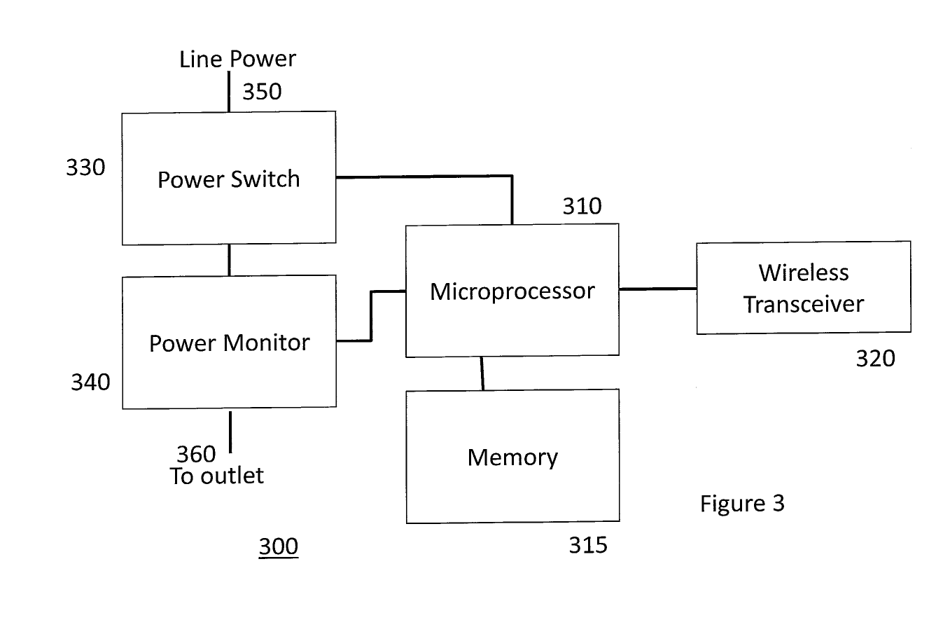

FIG. 3 is a block diagram of a remote controlled outlet 300 that may operate as remote outlet 130 in automation system 100. Outlet 300 may include any of the features of the power supply disclosed in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference.

In one embodiment, the outlet 300 may include a microprocessor 310 that may be configured to run software stored in a memory 315. A wireless transceiver 320 connects the outlet 300 to a control device such as, but not including, the switch device 120 or control 110. The transceiver may operate on any suitable protocol, including, but not limited to, 802.11, zigbee, X10, or any other wired or wireless protocol known in the art. Line power from, e.g., a main power grid of a structure, enters the device at connection 350 to a power switch 330 controlled by the microprocessor 310. The power switch 330 may be operable to connect or disconnect the line power to the outlet 300 and any load(s) 360 connected thereto. Power switch 330 may be manually controlled and/or may be remotely controlled via, e.g., control 110 and/or mobile device 170. The power switch 330 also may be operable to reduce the voltage and/or current delivered to the load 360, thereby providing a dimming function. Power monitor 340 may be configured to measure the consumption of power by the load 360 coupled to outlet 300. The measured power data is sent to the microprocessor 310, and may be transmitted to another device/component in the automation system 100 using the wireless transceiver 320. The power monitor 340 may also measure noise on the line to the outlet 300, as described in U.S. application Ser. No. 13/672,534, entitled “SYSTEMS, DEVICES, AND METHODS FOR AUTOMATION AND ENERGY MANAGEMENT,” filed on Nov. 8, 2012, the entirety of which is incorporated herein by reference. Outlet 300 may include an interface to load 360 (e.g., a receptacle) that can be any connection to provide power to a device including standard 2 or 3 pin power outlets, 220V outlets, international standard outlets, and may also include wireless transfer of power such as a wireless charger.

Monitoring and analyzing the noise on the power supply can be used to determine the type of load present, as discussed and taught in detail in U.S. Pat. No. 8,094,034. According to one embodiment of the present disclosure, the apparatus and method disclosed herein may be used to further monitor an entire structure to determine what loads are turned on or off and corresponding user activity is then inferred.

By monitoring the power consumption characteristics of the load coupled to the outlet 300, characteristics of the device may be determined, using the techniques taught in U.S. Pat. No. 8,094,034. In addition to the methods thought in the '034 patent, any suitable means for identify one or more characteristics of a load may be used. Based on the characteristics, the load (e.g., an electrical device coupled to the outlet) can be beneficially and intelligently controlled, for example an outlet supplying power to a television may disable power to reduce the power drawn by the device, but an outlet providing power to a clock radio or a refrigerator would remain energized, and thus to enhance the users environment, reduce energy consumption, and ease setup of automation systems.

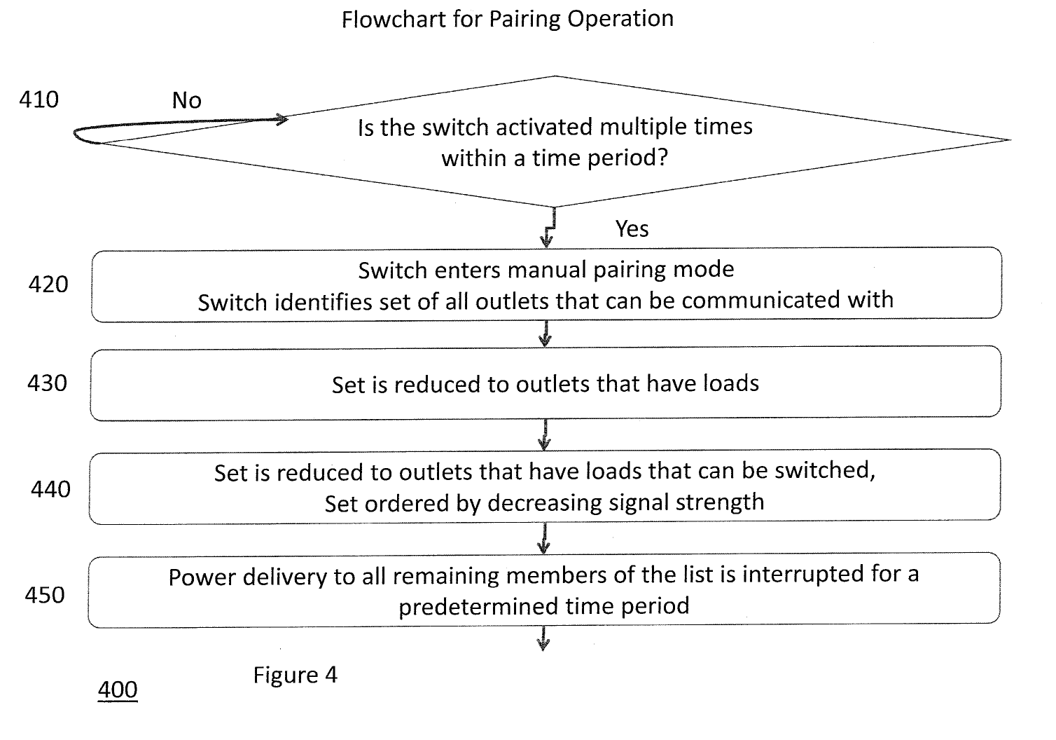

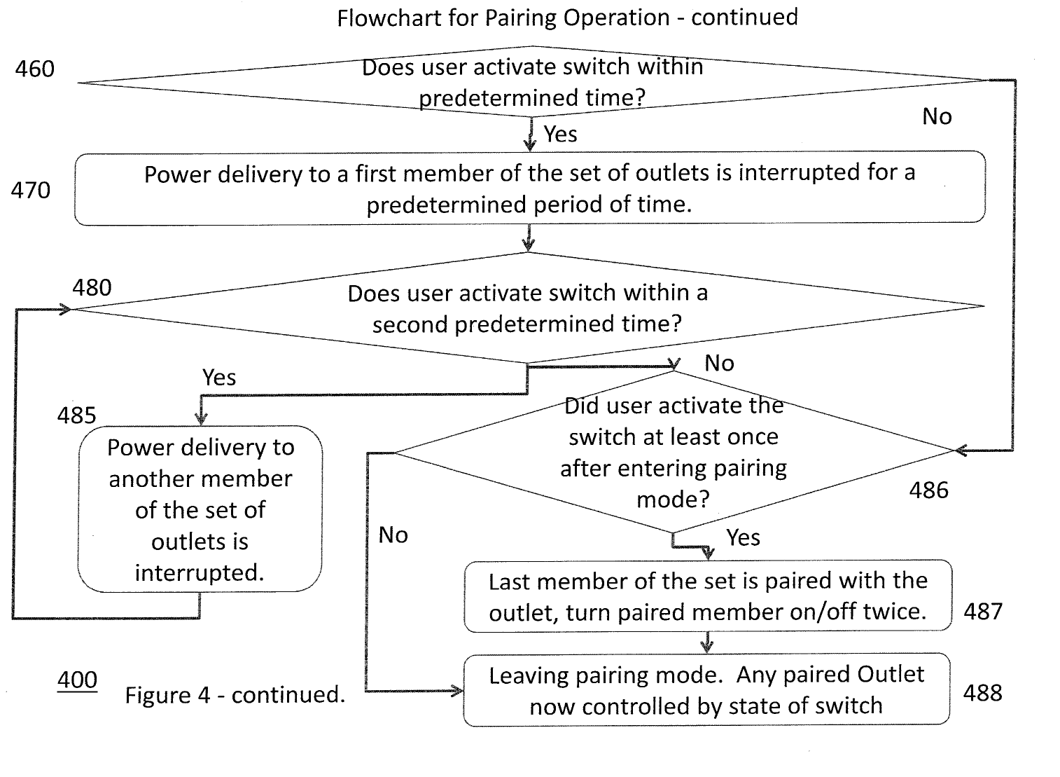

FIG. 4 is a flowchart of an exemplary method 400 to associate (e.g., to pair or link) a remote switch such as, e.g., switch 120, with a remote outlet such as, e.g., outlet 130. One or more steps of the method may be combined, eliminated, or performed in an order different than illustrated in FIG. 4.

At step 410, a monitoring mechanism in the switch 120 may monitor the state of the switch and identify whether the switch is an “ON” position, an “OFF” position, or an intermediate position. The monitoring mechanism may also be configured to monitor whether the state of the switch has been changed multiple times within a predetermined period of time or otherwise put in a pairing mode. If the switch is activated multiple times such as, e.g., on/off/on/off within a predetermined time period such as, e.g., 3 seconds, then the switch may enter a pairing mode and execution proceeds to step 420. If the switch is not activated multiple times in a predetermined time period such as 3 seconds, the switch remains in normal operation mode. That is, the switch continues to control power delivery to whatever outlet or load it is already controlling. In one embodiment, the monitoring mechanism may be configured to detect a position of the switch 120. In another embodiment, the monitoring mechanism may be configured to determine whether energy is flowing through the switch 120.

At step 420, the automation system 100 creates a list of all the outlets 130 that the particular switch 120 can communicate with. The list can be determined by the switch 120 sending a signal, e.g., a wireless signal, using, e.g., WiFi Transceiver 230 or transceiver 235, the signal causing outlets or devices that receive the signal to respond with the identity of any loads coupled thereto. As alluded to above, the identity of particular loads may be determined e.g., by comparing power consumption and electrical noise generated by a particular load. In some embodiments, the list may be preprogrammed into a memory of the automation system 100, or the list may be determined using other means as is known in the art. It is envisioned that a single outlet with, e.g., two plug receptacles may be treated as two items for this list, thus enabling two devices plugged into a single outlet to be individually or collectively controlled. That is, each plug receptacle of an outlet 300 may be configured to independently communicate with a switch 120 in response to a signal emitted by the switch 120.

At step 430, the list of outlets or devices may be reduced. For example, outlets without connected appliances or other electrical devices that are not drawing power may be removed from the list. Remote outlets such as outlet 130 may include a power monitor 340 that enables the outlet to determine if an appliance is connected and drawing power. Thus, an outlet may determine if an appliance/electrical device is plugged in and turned on, and the information may be communicated by the outlet 130 to control 110, switch 120, or any component of automation system 100. Outlets or devices without loads may be removed from the list. It is envisioned that step 420 and 430 may be combined in some embodiments. The remote switch 120 may send a message using WiFi transceiver 230 or transceiver 235 requesting outlets respond if a power consuming device is coupled thereto. The outlet 130 would determine if an appliance is attached and drawing power, and respond with the identity of devices connected thereto. An outlet with multiple receptacles may respond with a single identity if a single device is plugged in and drawing power, may respond with multiple identities if the outlet has multiple receptacles and more than one receptacle has an appliance plugged in and drawing power, or may not respond if the outlet does not detect a connected appliance drawing power or if the connected appliance is not drawing power exceeding a threshold. By responding, it is envisioned that the outlet will be configured to receive a signal, e.g., an electrical or radiofrequency signal, emitted by a switch, and then in turn emit a response signal which will be received by the switch. The response signal may include information pertaining to one or more characteristics of a load coupled to the outlet 130. In an alternate embodiment, the outlet may respond with and indication that no load is present.

At step 440, a list is generated, the list including the outlets and corresponding devices that can be controlled by the switch 120, and have appliances attached. In some embodiments, the list may be further reduced by eliminating those outlets coupled to a load that is in an inoperative, not present, or operating in a reduced power consumption state. In addition, the list may be arranged in any suitable order. For example, the list of outlets may be ordered by decreasing signal strength. This would roughly order the outlets and corresponding devices that can be controlled by the switch, in a sequence of those closest near the top of the list with the highest signal strength, to those farthest at the bottom of the list with the lowest signal strength.

At step 440, the list may also be reduced by any devices or appliances that are essential and cannot or should not experience an interruption in power supply. As alluded to above, outlets 130 may include a include power monitor 340 that can detect if the connected appliance is drawing power as well as characteristics of the power drawn such as, e.g., quantity, time characteristics, noise characteristics, etc. By monitoring these characteristics and comparing them to a database of devices and their power characteristics, the type or category of electrical device/appliance may be identified. If the device is determined to be a refrigerator, clock radio, a ventilator, or another device that may be identified as not switchable or incapable of experiencing an interruption in power delivery, then the device may be removed from the list, even though the device is connected and drawing power. The database may be stored in the automation system 100 or may be remotely accessible via the cloud 140. The comparison may be performed in or by the control 100, the outlet 130, the switch 120, or in a remote server accessible through cloud 140.

It is envisioned that steps 420, 430, and 440 may be combined or be performed in any suitable order, with one or more portions of any of these steps being omitted. A single message signal may be sent from the switch 120 to outlets 130 and devices coupled thereto and/or controller 160, where the devices and outlets respond with information relating to an identity of a device coupled to the outlet 130 or controller 160 if the outlet is connected to an appliance, the appliance is drawing power in excess of a threshold, and/or the appliance is not identified by the power consumption characteristic as an essential appliance for which power supply should not be interrupted.

During step 450, all outlets 130 and devices coupled thereto that remain in the list may be turned off, a time period is waited such as, e.g., 2 seconds, and the devices and outlets are turned back on. In other words, delivery of electrical energy to all outlets and corresponding devices is interrupted for a predetermined period of time. This would allow the user to see the devices turn off and on, thereby providing indication of which devices are available for pairing with the switch that has been put into pairing mode. As discussed herein, the outlets 130 may include other means (e.g., an LED light or a speaker) for providing an indication to a user which outlets are available for pairing with a particular switch.

At step 460, if the user does not activate the switch 120 within a predetermined time period, such as, e.g., 5 seconds, execution of the method may proceed to step 486. If the user does activate the switch 120, however, where the activation may include turning the switch on and then turning the switch off at step 460, then execution may proceed to step 470, where power delivery to the first member of the set of outlets and coupled devices is interrupted for a predetermined time period, such as, e.g., 2 seconds, and then the power is turned back on. This will indicate to the user that the first device will be paired with the switch 120 if the switch 120 is not activated again while in pairing mode.

Following pairing with a particular outlet 130 or device coupled to an outlet 130, the switch 120 may transmit a signal (e.g., a wireless signal) to all outlets 130 informing those devices and outlets to cancel any pairing with the switch that is in pairing mode. Since the user has put the switch into pairing mode, and selected a possible device for pairing, control of any previously paired device should be also disabled. This may be accomplished by the switch 120 sending/emitting a signal carrying the switch's identification and a request to cancel prior pairings. All devices and outlets receiving the message would compare the identity of the switch 120 to information stored in the device or outlet memory. If the identification of the switch sending the signal matches information stored in the device or outlet memory, such as memory 315, then the device or outlet may modify information stored in the memory so that the device or outlet will no longer respond to the switch in pairing mode. This facilitates remapping switches to new devices or outlets.

At step 470, the user may activate the switch 120 again before a time period expires such as, e.g., 5 seconds. If the user does activate the switch 120 before the time period expires, execution of the method may proceed to step 485 where the next member of the set of outlets and devices is turned off, and then turned back on after a short time period, execution then passes back to step 480. If the end of the list is encountered at step 485, the next member selected may be the first member of the set.

If the user does not activate switch 120 during step 480 before the time period expires, then execution proceeds to step 486. At step 486, if the user has not activated the switch 120 at least once after pairing mode was entered, then the user may have entered pairing by mistake, no change is made to the pairing of the switch 120, and the switch 120 exits pairing mode at step 488. The switch 120 may be configured to wait another predetermined period of time (e.g., 10 seconds) to determine if it will be activated when in pairing mode before pairing mode is exited.

At step 486, if the switch has been activated at least once within the predetermined time period after entering pairing mode, then execution proceeds to step 487. During step 487, the last member of the set of outlets for which power was interrupted is paired with the switch. Subsequently, power delivery to the paired outlet/device is interrupted twice for a brief pre-determined period of time, such as, e.g., 2 seconds. Doing so will provide an indication to the user that the selected outlet/device has been paired with the switch 120. In addition, outlets 130 and switches 120 may include an integrated light source, such as, e.g., an LED. Thus, rather than interrupting power delivery to the outlet and any coupled devices, the LED on particular outlets may flash to indicate when, e.g., they are selected for pairing and/or paired with a particular switch. In this manner, it is contemplated that interruption of power delivery may be avoided during a pairing exercise, so as to avoid electrical malfunction of devices/appliances.

If the user does not activate the switch 120 within a time period such as, e.g., 5 seconds after the switch 120 enters pairing mode, then execution proceeds to step 488 and the switch 120 exits pairing mode. If the switch 120 is on, any paired device is turning on, if the switch 120 is off, the paired device is turned off. Alternately, the switch 120 may request that the outlet 130 toggle operation when the switch 120 is activated, for example, if the outlet is on and the switch is activated, the outlet may toggle off, or, alternatively, if the outlet is off and the switch is activated, the outlet may toggle on. That is, if the device or outlet is on, and the switch 120 is activated, then the device or outlet 130 may be turned off, and if the device or outlet 130 is turned off when the switch is activated, then the device or outlet maybe turned on, regardless of the switch position relative to its “ON”/“OFF” positions prior to pairing.

In some embodiments, after a switch is paired, entry into pairing mode for that particular switch may be disabled so that multiple operations within a predetermined time period may no longer enable the pairing mode. In addition, a user may be capable of manually disabling pairing mode by adjusting a safety control on a switch 120. This may be advantageous to prevent inadvertent activations from, e.g., children causing a switch 120 to enter pairing mode and affecting current pairings. If the remote switch loses pairing information, or the remote outlet no longer responds to the remote switch, then the pairing mode may again be permitted. A light source may be activated on a switch experiencing pairing difficulties such as, e.g., loss of pairing information. It is expected that the switch may send a message when the user changes the state of the switch. A paired device would react to the message and may send a response to the switch acknowledging that the message was received. If a message is not acknowledged, the switch may declare that the pairing is no longer valid, and re-enable pairing mode. Then, future multiple activations would enable pairing mode in the switch.

In some embodiments, it is envisioned that a device capable of being paired with a switch 120 may be controller 160, e.g., which can close, open or otherwise control, e.g., a window treatment such as a shade, blinds, drapes, LCD film, or any other window covering or treatment. In addition, any suitable enhancements, such as, e.g., irrigation control, that can be controlled by controller 160 may be paired with a switch of the present disclosure. Method 400 is expected to apply to allow these enhancements to also be paired with remote switches. For example, a remote switch turned on may be equivalent to opening a window treatment, and a remote switch turned off may be equivalent to closing the window treatment. A remote switch that allows continuous input, such as a dimmer switch, may be paired to a window treatment control and may continuously adjust the state of the window treatment instead of strictly opening or closing the treatment. In addition, continuous input remote switches may also control intermediate states of operation.

The execution of method 400 may occur in the microprocessors located in the control 110, the switch 120, the outlet 130, controller 160, a server accessible via the internet cloud 140, or a combination of these.

Method 400 allows the user to step through the available outlets and corresponding devices for pairing by manually operating the switch to advance through a list of available outlets and corresponding devices. Alternately, once the switch is in pairing mode, the switch may automatically advance through the list, cycling power at each available outlet or device, with a time period pause between devices. Power delivery to the device or outlet would be briefly interrupted in a predetermined pattern such as on/off/on to indicate which outlet/device is presently selected. The user could manually operate the switch to indicate which outlet/device is to be paired. The switch may sequentially cycle through the list of possible outlets and devices one, two, or more cycles to provide the user multiple opportunities to select a desired outlet/device. If the user does not select an outlet or device within a predetermined time period, or a predetermined number of cycles, the switch would exit pairing mode after cycling through the list one or more times. If the user does indicate a selection for pairing by operating the switch when the desired outlet or device is selected, then the switch may send out a message to all devices to unpair (i.e., effectively clearing any previous pairings) the switch as a control device and then send a message to the user-specified device that it should pair with the switch.

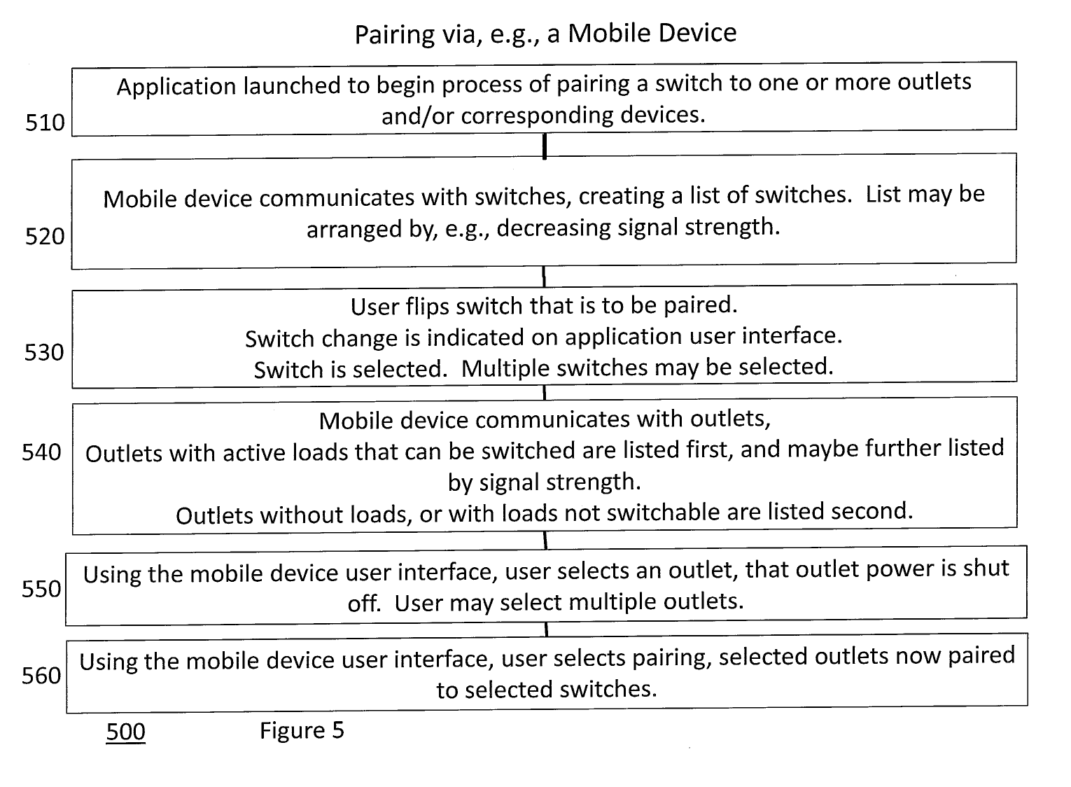

FIG. 5 shows a flow chart for using a mobile device 175 to assist with pairing of remote switches with outlets and their corresponding devices. One or more steps of the method 500 may be combined, eliminated, or performed in an order different than illustrated in FIG. 5. The mobile device 175 may be a smart phone, tablet, laptop, or any other device with a user interface, wireless transceiver, and a microprocessor, for example. Operation of the method 500 begins at step 510 where an application is launched on mobile device 175. In some embodiments, however, step 510 may include accessing a website to begin the pairing process. Furthermore, in addition to using a website and/or a mobile device, a building (e.g., a home) may be equipped with a user interface for pairing and de-pairing switches and the outlets/devices they control. It is envisioned that the interface may be mounted on a wall in a central location similar to a thermostat. The interface may include a digital display, allowing a user to graphically visualize switches, outlets/devices, and paired relationships. The interface may also include a touchscreen, buttons, or other means to accept user inputs.

At step 520, the mobile device 175 may communicate with remote switches (e.g., switches 120), remote outlets (e.g., switches 130), and other devices within range of the mobile device or within a particular structure. The mobile device 175 may send a signal asking for remote switches to respond, the switches may reply with their identity and the state of the switch. In other words, the mobile device 175, via, e.g., the Internet or cloud 140, may send a signal to all switches that are part of a structure. All switches receiving the signal may then respond with another signal including information relating to, e.g., the switch's location and whether the switch is in an “ON” position, an “OFF” position, or an intermediate position. The mobile device 175 may collect and tabulate the responses it receives. In addition, the mobile device may include software configured to create a list of the remote switches that respond. Furthermore, the list of remote switches may be arranged in any suitable order. For example, in one embodiment, the list of remote switches may be ordered by decreasing received signal strength, which may correspond to distance away from the mobile device. In addition, remote switches may be arranged or grouped by their location within a structure such as, e.g., by floor or room. In embodiments where response signal strength is used, the switches may be configured to receive and emit a wireless signal (via e.g., Bluetooth or radiofrequency). Accordingly, the mobile device 175 also may be configured to receive and emit a wireless signal. This will result in a list where the closest switch is near the top of the list, switches further from the mobile device would be further down the list. The list may include the switches and the state of each switch (e.g., whether the switch is in an “ON” position, an “OFF” position, or any suitable intermediate position). In addition, the mobile device 175 may be configured to display any pre-existing pairing relationships any of the switches may already have.

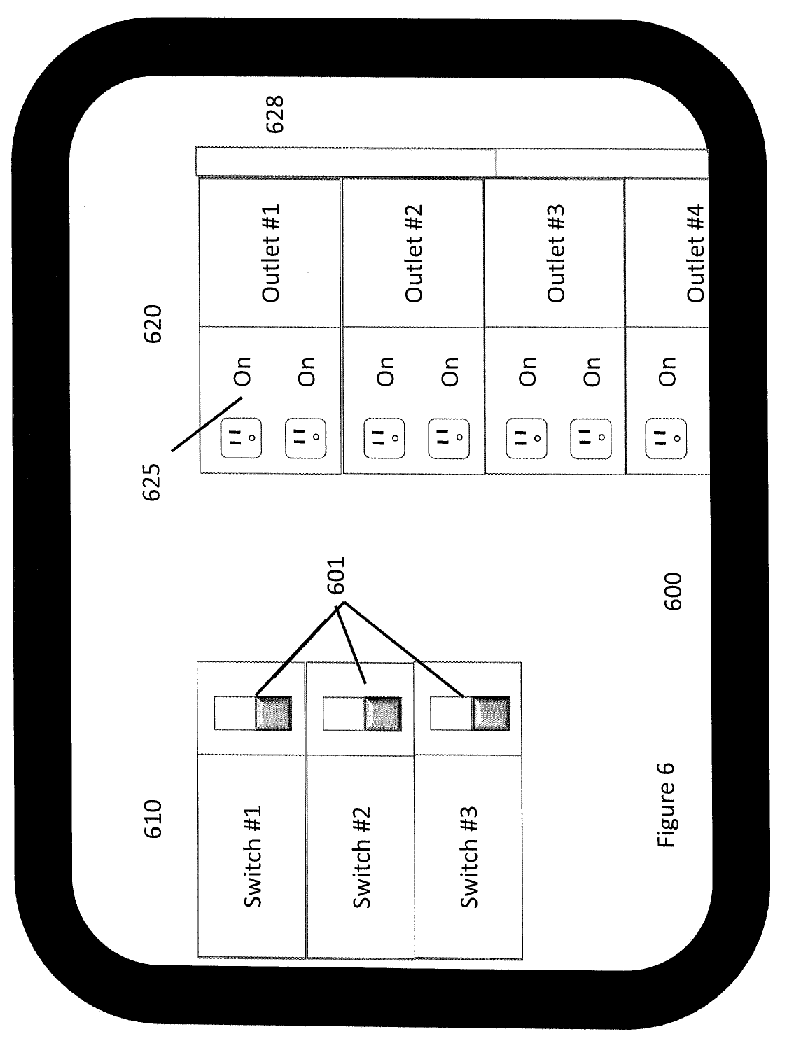

FIG. 6 shows an exemplary embodiment of a user interface 600 for, e.g., the mobile device 175. The user interface 600 also may be representative of a user interface provided within a structure, as alluded to above. Switches that are discovered are listed in the left column 610, for example. Column 610 may also include information relating to, e.g., a location of the switches within a structure. The signal strength of the signal returned from the switches is measured, the switch with the strongest signal is likely closest to the mobile device. Thus, the switch that returns the strongest signal may be listed first. In some embodiments, the user interface may also include a graphical representation 601 of each switch that responds and the state of each switch, and any pre-existing pairings. The user interface may further include a column 620 displaying outlets/controlled devices. The signal strength returned (in response to a signal from mobile device 175) from the outlets or controlled devices also may be measured, and the outlet/device with the strongest signal is listed first. Of course, the outlets/controlled devices may be ordered in any suitable manner. For example, the outlets/controlled devices may be ordered by the type of load connected to the outlets or the type of devices being controlled. Column 620 may also include additional data such as the status of each receptacle of each outlet 625, i.e., whether it is enabled “ON”, disabled “OFF,” whether a load is connected to a particular receptacle, whether the load is drawing electrical energy, and/or whether the load is an operational mode. Column 620 may also include, among other things, identifying information of one or more outlets. For example, column 620 may include information relating to a location of an outlet within a particular structure. Column 620 may also include information relating to an identity of a load connected to a particular outlet. The lists 610, 620 of switches and outlets may be longer than can be displayed on an available display, and a scroll bar 628 may be used as-is known in the art.

At step 530, the user adjusts a position or state of the switch (by, e.g., flipping the switch) that the user desires to pair to an outlet/device. The subject switch may then send out a message via a wireless signal that the switch state has changed, the mobile device or another control panel may receive the message, and consequently update the user interface (e.g., in real-time) to show the switch changing state. The user may then select one of the listed switches to be paired on the user interface of the mobile device. Multiple switches also may be selected. The user may then select one or more outlets/devices to be paired with the selected outlets/devices, as discussed in greater detail below.

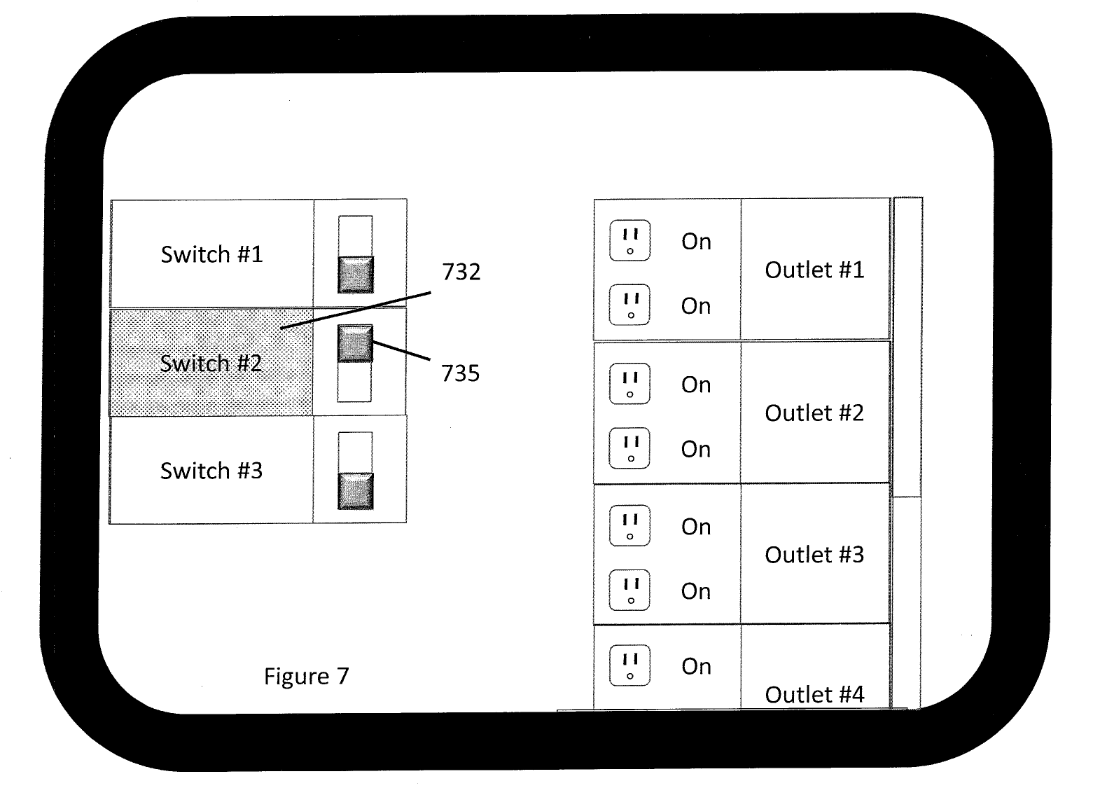

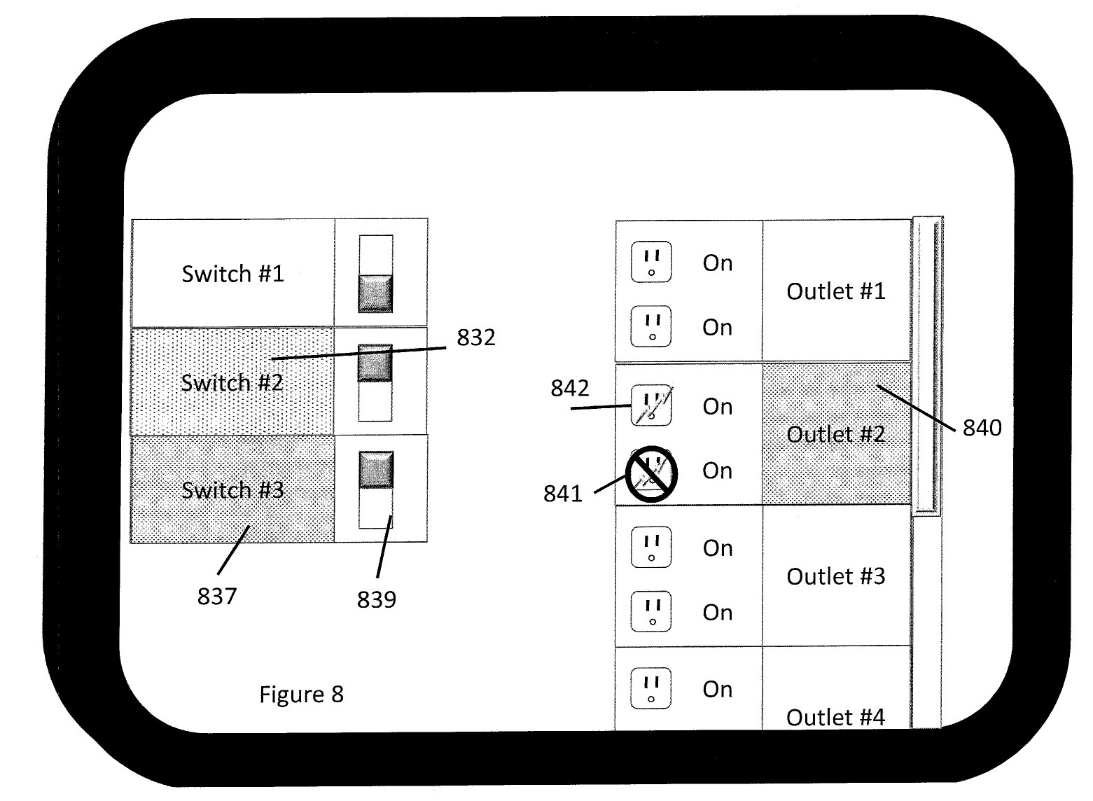

FIG. 7 shows an exemplary user interface when the user operates a switch. In this Figure, the user has operated switch #2. The icon for switch #2 is highlighted 732, and the switch is shown in the up position 735. FIG. 8 depicts an exemplary user interface after the user has activated switch #3. Switch #3 shows as selected (e.g., highlighted in a different color) on the user interface 837, the icon for the switch position is updated to the up position 839, and the highlight for the previously activated switch #2 is dimmed or changed to another color 832. Thus, the user can activate a switch in the house and easily determine which switch icon on the user interface correlates to the physical switch. If the switch the user activates is coupled to an electrical device, such as, e.g., a floor lamp, the lamp may be turned on. The outlet to which the lamp is coupled may detect that the power consumed by a load (i.e., the lamp) has changed, and reports the change to the mobile device via a wireless signal. The user interface may then highlight (e.g., in a different color) the outlet that has reported the load change 840. The color of the outlet with the load change may correspond to the color of the switch activated by the user. The user interface in FIG. 8 also shows that one of the receptacles is not drawing any power 841, signified, e.g., with a lightning bolt in a crossed circle, and the receptacle with the active load may be indicated, e.g., with the lightning bolt 842. Any suitable indication may be substituted for the indications described herein.

At step 540, the mobile device communicates with remote outlets 130 and devices that can be controlled such as a controller 160 for, e.g., a window treatment. The mobile device would send out a request via a wireless signal to outlets and devices. The outlets and device may respond with a wireless signal including information relating to one or more characteristics of the outlets and/or devices coupled thereto. The outlets and devices may include information on the appliance/device electrically coupled to the outlet. If the automation system 100 has determined or received information relating to identity characteristics of any of the appliances coupled to controlled outlets, this information may be communicated to the mobile device and displayed on the mobile device user interface. For example, if it is determined that a television is coupled to a controlled outlet, a graphic (including, e.g., symbols, letters, and/or images) may be displayed adjacent the outlet 130 to which the television is coupled. With reference to FIG. 8, e.g., an image relating to a television may be displayed adjacent the receptacle 842. The identity information may come from any component of automation system 100, including, but not limited to, an outlet 130, a control 110, or a switch 120. If the identity of the appliance indicates that the appliance should not be disconnected from power delivery, that information may also be indicated on the mobile device user interface. In other words, if it is determined that a particular appliance or device is an essential device (i.e., a device which cannot or should not experience an interruption in power delivery), an indication of the essentiality of the device may be also displayed adjacent a receptacle, such as, e.g., receptacle 842, to which the device is coupled.

At step 550, using mobile device user interface, the user may select one or more outlets or devices coupled thereto. The user may indicate that an outlet/device should be turned off by, e.g., touching the user interface, the mobile device sends a message (e.g., via a wireless signal) to the indicated outlet/device, and power delivery to the outlet/device may be terminated and/or reduced, which would turn off any device connected thereto. Thus, the user can confirm that the selected outlet on the user interface is actually correlated with the device the user wishes to control with a remote switch. Any suitable representation other than line 1060 may be used, however.

At step 560, using the mobile device user interface, the user selects to pair one or more selected switches with one or more outlets and/or corresponding devices. Subsequently, the mobile device may send a message via a wireless signal to the automation system 100 to pair the selected outlet(s)/device(s) with the desired switch(es). As alluded to above, more than one switch and outlet may be selected and paired.

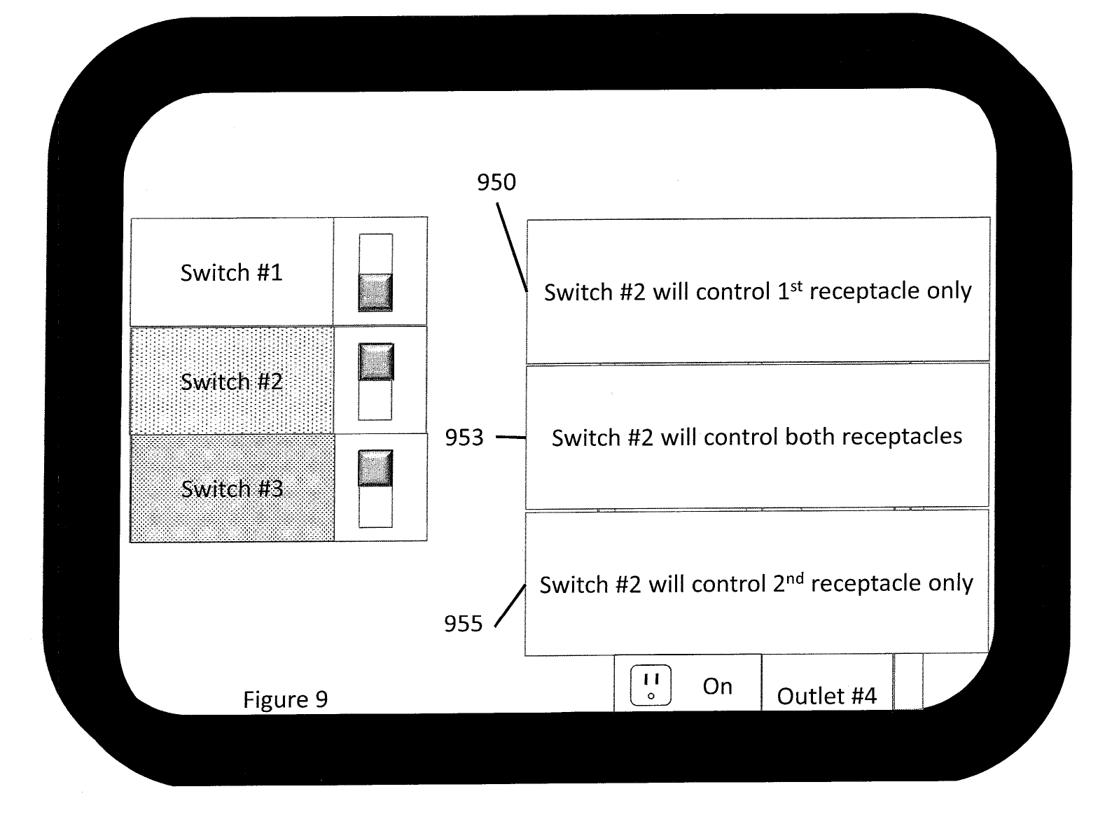

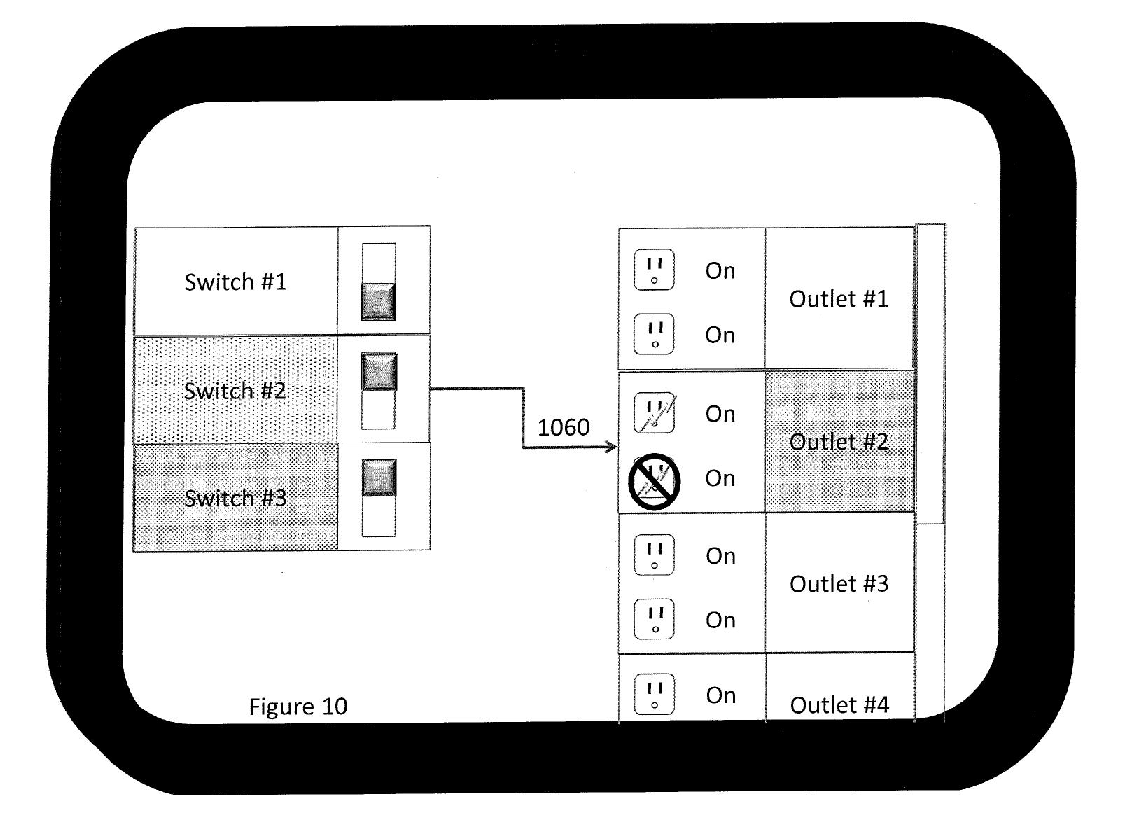

FIG. 9 shows an exemplary user interface. After selecting switch #2 and outlet #2, for example, the user interface may offer an option for the switch #2 to control the 1^{st} receptacle 950, both receptacles 953, or the 2^{nd} receptacle only 955 of a particular outlet. If the user selects to control both receptacles, then the display may update to FIG. 10. In particular, a line 1060 or other graphical representation may be positioned in between the two receptacles of outlet #2, thereby indicating that both receptacles will be controlled. In other words, the line 1060 connecting switch #2 to the center of outlet #2 indicates that switch #2 will control both receptacles of outlet #2. If only one receptacle was going to be controlled by switch #2, the line 1060 may terminate closer to one receptacle, as explained in greater detail below.

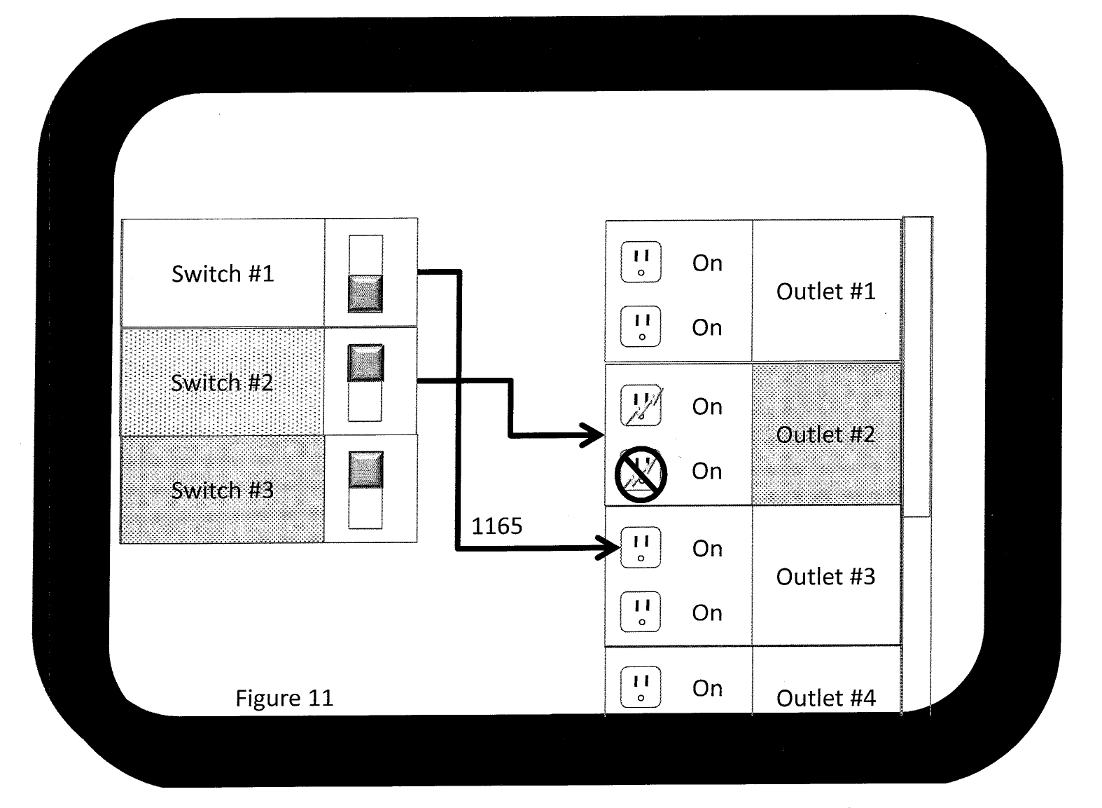

FIG. 11 depicts an exemplary user interface where switch #1 is controlling the first receptacle of outlet #3 only. This is indicated by graphical representation 1165. Activating switch #1 would cause the power delivery from the first receptacle of outlet #3 to toggle on or off with each activation. However, the second receptacle of outlet #3 would be unaffected by activations of switch #2.

By manipulating the user interface, the user may access each outlet or receptacle and selectively turn each outlet or receptacle on or off, independently or collectively. The user may also access information from each of the home automation devices such as model number, software version, hardware version, data from the power monitor of any device, data from sensors located in any device, and/or any identifying characteristics of a load connected to one or both receptacles of the outlet.

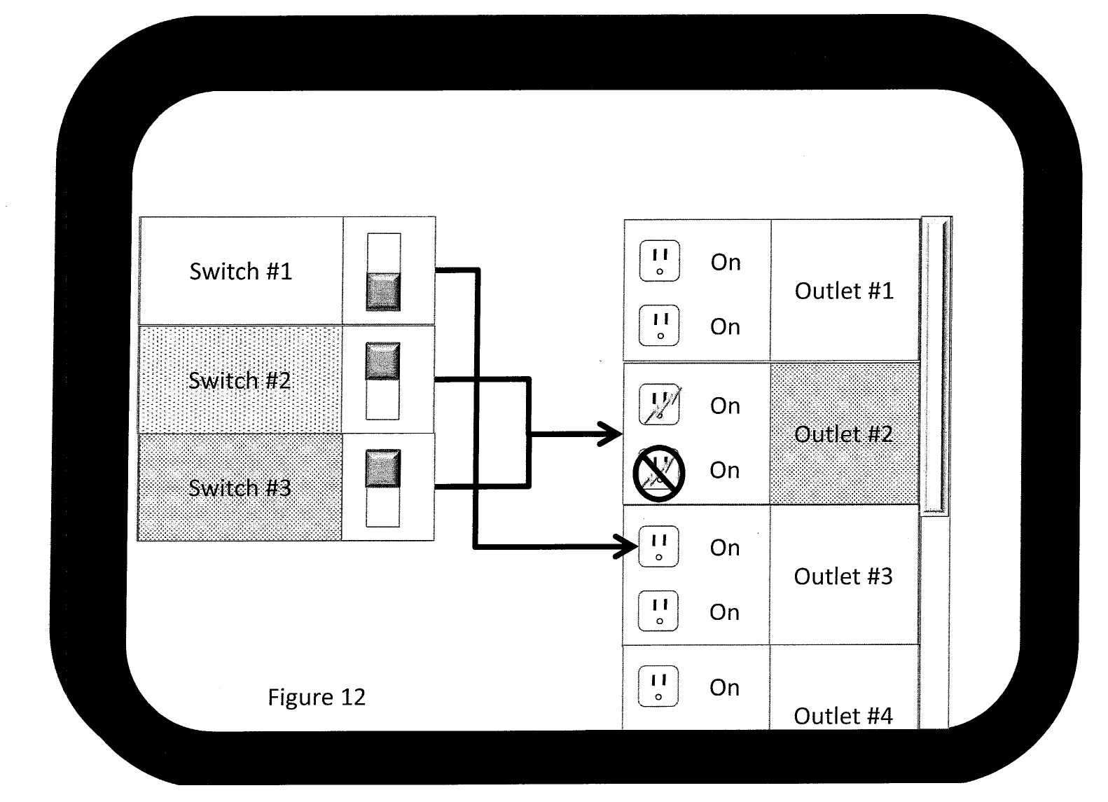

FIG. 12 shows an exemplary user interface where activating switch #3 or activating switch #2 would result in controlling the power delivered to both receptacles of outlet #2, so that the outlets may be toggled on or off. If the outlet is presently supplying power and switch #2 or switch #3 is activated, then the power supplied to both receptacles of outlet #2 would be disabled. If the outlet is presently disabled and switch #2 or switch #3 is activated then both receptacles of outlet #2 would be enabled. That is, the embodiment of FIG. 12 depicts the circumstance where two or more switches may be paired with and control a single outlet, for example.

In one embodiment, the user interface may be configured to allow a user to intelligently control the power delivery to one or more outlets and/or devices coupled thereto. That is, the automation system and/or user interface may be configured to execute pairing or unpairing of switches and outlets based on pre-programmed instructions. For example, the user interface may allow automatic pairing or de-pairing at certain times of the day, certain days of the week, or certain months of the year. In addition, the user interface may allow preferred pairing based on an identity of certain devices. That is, the user interface may be programmed to always pair a single switch with any outlet to which a particular device/appliance is connected.

It is proposed that an outlet or device with multiple outputs or receptacles may have some of the outputs activated and some deactivated. For example, in FIG. 12, outlet #2 may have the first receptacle turned on, providing power to any device that may be plugged in, and the second receptacle turned off, not providing power to any device that may be plugged in. Switch #2 and switch #3 may be configured to control both receptacles. If switch #2 or switch #3 are activated, the power delivery to both receptacles may be controlled. In other words, if the first receptacle of outlet #2 is on, second receptacle of outlet #2 is off, and switch #2 or switch #3 is activated, then first receptacle of outlet #2 would turn off, and the second receptacle of outlet #2 would turn on. In addition, if the first receptacle of outlet #2 is off, second receptacle of outlet #2 is on, and switch #2 or switch #3 is activated, then first receptacle of outlet #2 would turn on, and the second receptacle of outlet #2 would turn off. In this example, the two receptacles would always be in opposite states when controlled by the switches, allowing the user to configured the system such that one of two devices is powered on, and activating a switch associated with the outlet causes the receptacles to change the state of which device is enabled and which device is disabled.

Some devices plugged into the outlets may be identified as a protected class. Devices in the protected class may be appliances identified as a device not to be disabled, such as a refrigerator or a clock radio, security system component, medical device, or any other device or appliance that may be determined to be detrimental to disable the power to the device. The device or appliance may be identified by a characteristic of the power drawn by the device, it may be identified by a characteristic of the noise the device generates in a power line, it may be identified by a sensor attached to the automation system such as a camera, the device may communicate to the home automation system over a wired or wireless connection and identify itself, or the user may identify the device by manipulating a user interface to enter data about the device into the automation system. When a protected class device is known to be connected to the automation system, it may be displayed on a user interface to indicate that the outlet or receptacle providing power to the device should not be disabled. The user interface may further indicate that a receptacle or outlet powering a protected class device is not a valid selection for pairing. Should the user manipulate the user interface on the controller or mobile device to turn off an outlet or receptacle powering a protected device, the user interface may indicate that executing the chosen action would disable a protected device. A password may be required prior to executing the action of disabling a protected class device or appliance.

In another embodiment, switch 120 may be removably attached to a wall. When removed from the wall, prongs for a wall plug extending from switch 120 may be moved from a stored position to an extended position allowing the switch 120 to be plugged into an outlet 130. When the switch is plugged into an outlet the switch may recharge a battery associated with the switch. When the switch is plugged into an outlet, the switch may associate with the outlet so that after unplugging the switch from the outlet, operation of the switch user interface will control (e.g., wirelessly) the outlet the switch was plugged into. Moving the plug of the switch into an extended mode may cause the switch to enter into a pairing mode, a charging mode for a battery, or both a pairing and a charge mode. Moving the plug of the switch into a stored position may cause the switch to resume a normal operating mode, where operation of the switch controls a paired device or outlet.

The switch may include a user input device such as a button, slide, touch screen, etc., which may enable the switch to pair with an outlet when plugged in. The switch could be plugged into a first outlet, and the user interface of the switch may be manipulated by the user enabling the switch to pair with the outlet. The switch may then be plugged into a second outlet, for example an outlet located above a kitchen counter. The switch would draw power from the second outlet, and operating the switch may control the first outlet that is paired with the switch.

It is understood that the embodiments disclosed herein are not limited to the particular forms, embodiments, and examples illustrated and described. The methods and apparatuses of the present disclosure can be practiced with and modifications and variations that do not depart from the spirit and scope of the disclosure.

Embodiments of the present disclosure may be used in connection with any structure, including, but not limited to, homes, offices, business, schools, churches, and/or sporting complexes. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

We claim:

1. A method for associating at least two components of a plurality of components of a building automation system, the method comprising:
operating a first component of the at least two components in a first mode to issue commands to one of the other components of the automation system and a second component of the at least two components, wherein the first component is a control device and the second component is controlled by the first component; and
operating the first component in a second mode, wherein the second mode facilitates altering a relationship between the first and second components.

2. The method of claim 1, wherein the first component is configured to control a flow of electrical energy at the second component.

3. The method of claim 1, wherein the first component is configured to receive a user input.

4. The method of claim 3, wherein providing multiple user inputs within a predetermined period of time places the first component in the second mode.

5. The method of claim 1, wherein the at least two components include at least a third component, wherein the second and third of the at least three components define a first set of components, wherein the first component is configured to individually or collectively control each of the components of the first set of components.

6. The method of claim 5, wherein at least one of the components in the first set of components is coupled to an electrical device.

7. The method of claim 6, wherein at least one of the components in the first set of components is coupled to an electrical device drawing electrical energy from the at least one of the components.

8. The method of claim 7, wherein at least one of the components in the first set of components is connected to an electrical device determined to be essential and should not experience an interruption in power delivery.

9. The method of claim 8, wherein the components of the first set of components are ordered by proximity to the first component.

10. The method of claim 9, where the first component is configured to measure a signal emitted by the second and third components.

11. The method of claim 10, wherein proximity to the first component is determined by measuring a magnitude of the signals emitted by the second and third components.

12. The method of claim 8, wherein, when in the first mode, the first component emits a signal to interrupt delivery of electrical energy from at least one of the components in the first set of components.

13. The method of claim 7, wherein, when in the second mode, activating the first component a first time causes the first component to emit a signal configured to be received by the first member of the first set of components that is closest to the first component, wherein the signal includes instructions to interrupt delivery of electrical energy from the first member of the first set of components.

14. The method of claim 13, wherein, when in the second mode, activating the first component a second time causes the first component to emit a signal configured to be received by another component of the first set of components, wherein the signal includes instructions to interrupt delivery of electrical energy.

15. The method of claim 14, wherein no further activations of the first component in the second mode causes the first component to exclusively control the another component of the first set of components.

16. A system for remotely controlling a delivery of electrical energy, the system comprising:
a switch including a user interface;
a plurality of components configured to delivery electrical energy; and
a mobile device;
wherein manipulating the user interface of the switch controls delivery of electrical energy from one or more of the plurality of components, wherein the mobile device is wirelessly coupled with the switch, and wherein the mobile device may be used to designate which of the plurality of components is to be controlled by the switch.

17. The system of claim 16, wherein the switch includes a plurality of switches.

18. The system of claim 17, wherein the mobile device includes a display configured to graphically represent each of the plurality of switches and each of the plurality of components.

19. The system of claim 16, wherein the mobile device is wirelessly coupled to each of the plurality of components.

20. The system of claim 18, wherein the display is configured to graphically represent one or more characteristics of each of the plurality of switches and each of the plurality of components.

21. The system of claim 20, wherein the one or more characteristics includes a mode of operation.

22. The system of claim 20, wherein the mobile device may be used to selectively control the delivery of power from at least one of the plurality of components.

23. The system of claim 20, wherein controlling the delivery of power includes first selecting the at least one of the plurality of components.

24. The system of claim 23, wherein selecting the at least one of the plurality of components temporarily interrupts the delivery of electrical energy to the at least one of the plurality of components.

25. The system of claim 23, wherein the mobile device may be used to associate one switch of the plurality of switches with at least one of the plurality of components, wherein, after successful association, the switch controls delivery of electrical energy from the at least one of the plurality of components.

26. The system of claim 25, wherein the at least one of the plurality of components is electrically coupled to an electrical device, wherein the at least one of the plurality of components is configured to monitor a quantity of electrical energy delivered to the electrical device.

27. The system of claim 26, wherein the quantity of electrical energy is displayed on the mobile device.

28. A wireless electrical energy control device, comprising:
an actuator for controlling a flow of electrical energy, wherein, in a first position, the actuator allows electrical energy to flow, and, in a second position, the actuator selectively prevents energy from flowing;
an electrical coupling for operably connecting the control device to an electrical outlet, wherein the electrical coupling is configured to transition between a first stored configuration and a second extended configuration; and
a power source, wherein physically connecting the control device to the electrical outlet configures the control device in such a manner that the actuator is capable of controlling a flow of electrical energy from the electrical outlet when the control device and electrical outlet are not connected.

29. The wireless electrical energy control device of claim 28, wherein the power source includes a rechargeable battery, and wherein the rechargeable battery is configured to recharge when the control device is physically connected to the electrical outlet.
